(19) United States
(12) Patent Application Publication
(10) Pub. No.: US 2011/0059731 A1
(43) Pub. Date: Mar. 10, 2011

(54) TECHNIQUES FOR DISCOURAGING CELL PHONE USAGE WHILE DRIVING A VEHICLE

(76) Inventor: George Gregory Schivley, Lake Orion, MI (US)

(21) Appl. No.: 12/875,425

(22) Filed: Sep. 3, 2010

Related U.S. Application Data
(60) Provisional application No. 61/239,952, filed on Sep. 4, 2009.

(51) Int. Cl. H04M 3/493

(52) U.S. Cl. 455/414.2

(57) ABSTRACT

A surcharge is to be paid by a cell phone user if it is determined that the cell phone is being used while driving a vehicle. In a disclosed embodiment, a GPS device in the cell phone transmits the location of the cell phone when the cell phone is first being used. After a suitable delay, the GPS device in the cell phone transmits another signal about the location of the cell phone. If it is determined that the distance between the two locations is significant, then it is determined that the cell phone is likely being used while driving a vehicle and a surcharge is applied to the user's account.

### TECHNICAL FIELD

This application relates to cell phones and, more particularly, techniques for discouraging cell phone usage while driving a vehicle.

### DISCUSSION

It is well documented that using a cell phone while driving a vehicle causes distraction of the driver and can sometimes result in accidents. Consequently, driving while using cell phones should be discouraged. Some countries have completely banned the use of handheld or hands free phones while driving. In the United States, some states have made it illegal to use a handheld phone while driving, while other states and cities have enacted or are considering enacting legislation that restricts texting or talking on cell phones while driving.

A complete ban on all cell phone usage while driving has not been widely enacted for a variety of reasons. Nevertheless it is almost universally recognized that the use of cell phones while driving should be discouraged.

### SUMMARY OF THE INVENTION

In accordance with the preferred embodiment of this invention, techniques are described for discouraging cell phone usage while driving yet not completely banning all such usage. In accordance with the teachings of this invention, the cell phone user is charged a monetary amount if it is detected that the cell phone is being used under circumstances likely to indicate that the user is in a moving vehicle. In one embodiment, a surcharge is added to the cell phone user's statement if it is determined that it is likely that a call or text message was sent while the user was driving a vehicle. One technique for determining whether the use of a cell phone while driving has occurred is to use the GPS system that is found in most cell phones. These GPS systems can track the location of their respective cell phone. Thus, it is possible to determine whether the cell phone is moving from location to location while being used. Such movement would indicate with a high degree of probability that the user is driving a vehicle while using the cell phone. If this is detected, the user's cell phone account would automatically be charged with a surcharge in a suitable amount high enough to discourage such usage. On the other hand, if the driver considers the phone call to be important enough to incur such a surcharge, he is free to do so. This approach would discourage cavalier usage of cell phones while driving, while at the same time not requiring a complete ban of all such use. This technique is likely to be considered a suitable compromise and easier for countries and states to enact such laws. In addition, the collection of such surcharges would be a source of revenue.

### BRIEF DESCRIPTION OF THE DRAWINGS

FIG. 1 diagrammatically illustrates a system for carrying out an embodiment of the invention;

FIG. 2 is a block diagram of a cell phone account management system for generating a statement to the cell phone user;

FIG. 3 is a flow chart illustrating broadly the techniques and methods for carrying out an embodiment of the invention; and

FIG. 4 is an example of a user's cell phone statement showing the implementation of the surcharge.

### DESCRIPTION OF THE PREFERRED EMBODIMENTS

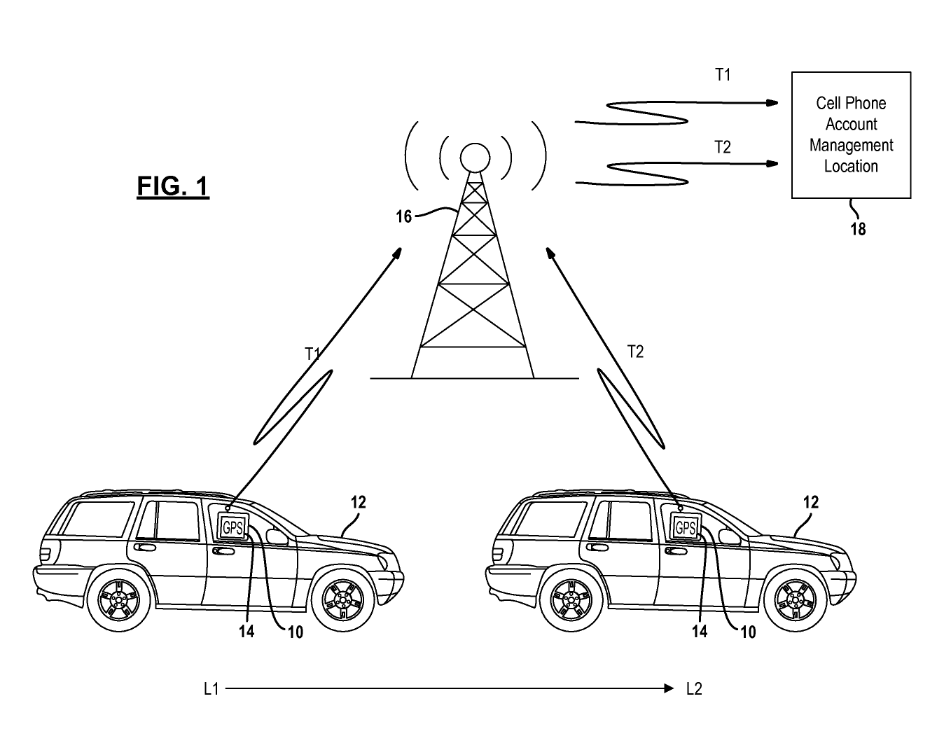

FIG. 1 diagrammatically illustrates a system showing the major components for carrying out the teachings of one embodiment of this invention. A cell phone 10 is shown in a vehicle 12 that is moving from location L1 to L2. The term “cell phone” should be broadly construed to include all mobile phones including portable wireless devices capable of voice or text messaging as well as similar fixed devices mounted in a vehicle. The cell phone 10 has the capability of sending information about its location. For example, cell phone 10 can include a global position system (GPS) device 14 that uses well known techniques for determining the location of the cell phone 10 at any particular time. Various other techniques are also envisioned for sensing the location of the cell phone.

Conventionally, the cell phones transmit information to cell phone towers such as tower 16. Tower 16 can relay the cell phone transmission to other locations. Here, the transmission from the cell phone tower 16 is sent to a cell phone account management location 18. The management location determines and stores information about the timing of a cell phone call and the location of the cell phone 10. This information would be in addition to transmission of the voice or text to the desired recipient.

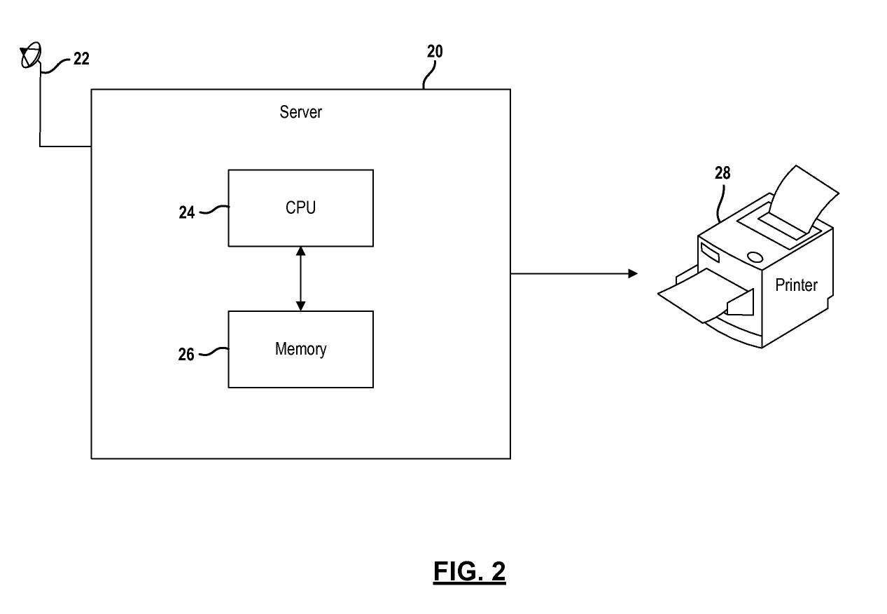

The account management location 18 includes sufficient computerized systems to store the pertinent data and calculate any allocable surcharges. For example, as shown in FIG. 2, management location 18 includes a server 20 that receives wireless cell phone transmissions via antenna 22. Of course, other modes of wireless transmissions such as over the internet can also be employed as will become apparent to one skilled in the art. The server 20 includes a central processing unit (CPU) 24 and associated memory 26, as well as suitable devices for generating a statement for the cell phone user, such as printer 28.

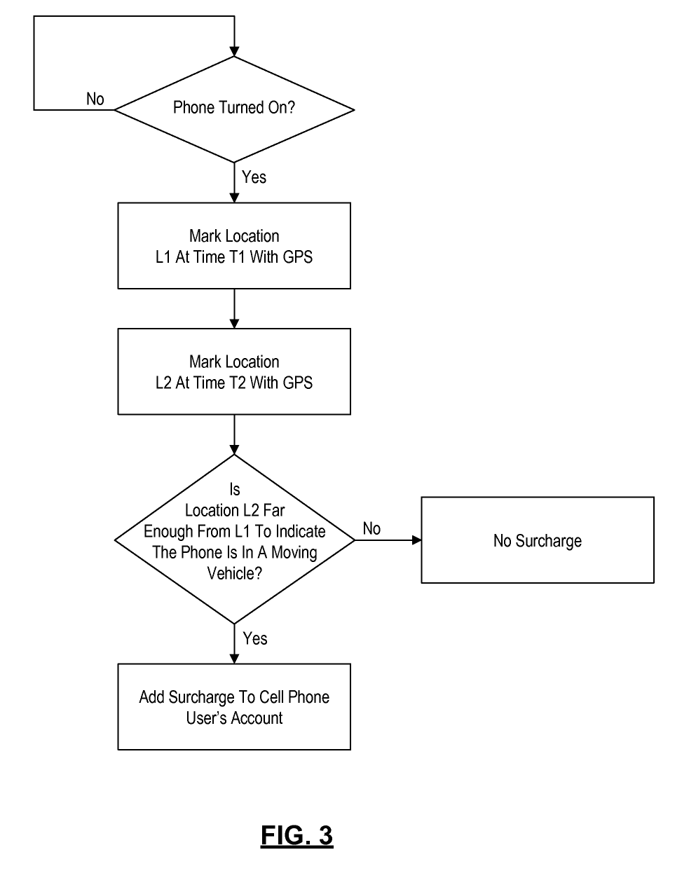

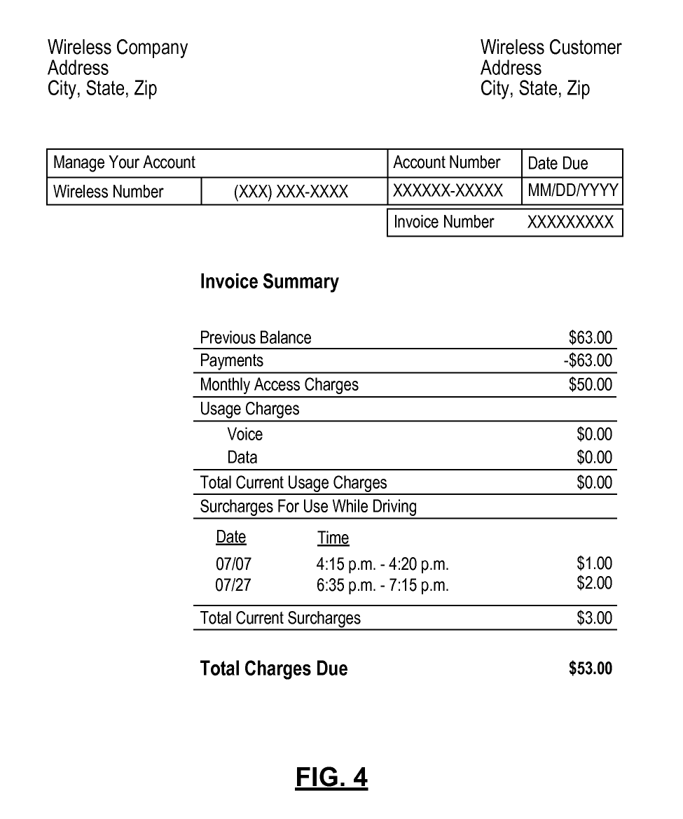

With additional reference to FIG. 3, an example of a method of practicing this invention will be described. When the cell phone 10 is turned on, it generates a transmission at time T1. This transmission may include such information as the time that the call is initiated and the location of the cell phone as provided by GPS 14. Alternatively, the management location can determine this information from data including in the transmission. After a suitable delay (perhaps after 15 seconds or so), the GPS signal from GPS 14 is again detected by management location 18. The server 20 uses the CPU 24 and information stored in memory 26 to determine whether there has been a significant difference between the locations L1 and L2 of the cell phone between time T1 and time T2 to indicate that the cell phone 10 is moving and likely being used to send voice or text messages while driving a vehicle. For example, if a call is being made between times T1 and T2 and the location of the cell phone is detected to be over 300 meters or so, then it is likely that the user is using the cell phone 10 while driving a vehicle, as compared to walking. If it is determined that it is probable that the user is using the cell phone while driving a vehicle, then the server continues to monitor the cell phone usage and store pertinent information so that it can add a surcharge to the user's monthly statement to reflect use of the cell phone while driving. A sample of the user's cell phone statement is shown in FIG. 4. The surcharges are itemized, for example, by date and length of call. The fee is also indicated which may be prorated, depending upon the length of the call. In FIG. 4, a five-minute call may incur a one dollar surcharge fee while a more lengthy call incurs a two dollar fee.

It is envisioned that the location 18 and responsibility for monitoring such cell phone usage and generating the user's statement will probably be accomplished by the cell phone provider, although other entities can be contracted by the state or country enacting the cell phone usage law. It is envisioned that the revenue generated by these surcharges would be significant and could be shared by the cell phone provider responsible for monitoring the cell phone usage and the state or country enacting the law.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for discouraging use of a cell phone while driving a vehicle, said system comprising:
a computerized account manager system that:
(a) receives and stores information about a location of a cell phone at a first time period when the cell phone is in use;
(b) receives and stores information about a location of a cell phone at a second time period when the cell phone is in use;
(c) determines whether the cell phone is likely being used while driving a vehicle by comparing the locations of the cell phone between the first and second time periods; and
(d) generates a surcharge to be paid by the cell phone user if it is determined that it is likely that the cell phone was used while driving a vehicle.

2. The system of claim 1 wherein the computerized account manager system generates the surcharge as part of an invoice to the cell phone user.

3. The system of claim 2 wherein the cell phone includes a global positioning system (GPS) that tracks the location of the cell phone.

4. The system of claim 3 wherein the cell phone is a portable, handheld, mobile wireless communication device.

5. A method for discouraging use of a cell phone while driving a vehicle, said method comprising:
(a) determining whether it is likely that a cell phone is being used while driving a vehicle; and
(b) charging the cell phone user a monetary amount to discourage such usage.

6. The method of claim 5 wherein step (a) is performed by:
wirelessly transmitting a first location of a cell phone when the cell phone is in use at a first time period;
wirelessly transmitting a second location of a cell phone when the cell phone is in use at a second time period; and
determining that the cell phone is likely being used while driving a vehicle if the locations of the cell phone between the first and second time periods exceed a given distance.

7. The method of claim 6 wherein the monetary amount is a surcharge added to the cell phone user's monthly statement.
